(19) United States
(12) Patent Application Publication
(10) Pub. No.: US 2024/0249710 A1
(43) Pub. Date: Jul. 25, 2024

(54) Sound Control Device, Method of Controlling Sound Control Device, Electronic Musical Instrument, and Non-Transitory Computer-Readable Storage Medium

(71) Applicant: YAMAHA CORPORATION, Hamamatsu-shi (JP)

(72) Inventor: Tatsuya IRIYAMA, Hamamatsu-shi (JP)

(21) Appl. No.: 18/626,882

(22) Filed: Apr. 4, 2024

Related U.S. Application Data
(63) Continuation of application No. PCT/JP21/37035, filed on Oct. 6, 2021.

(51) Int. Cl. G10H 5/00; G10H 1/00; G10H 5/10

(52) U.S. Cl. CPC G10H 5/005; G10H 1/0008; G10H 5/10; G10H 2220/361; G10H 2250/455

(57) ABSTRACT

A sound control device includes an obtainer and a determiner. The obtainer obtains performance information including sound pitch information indicating a sound pitch and sound volume information indicating a sound volume detected as a continuous quantity. The determiner determines a note start and a note end based on a comparison between the sound volume and a sound-volume threshold and based on a change in the sound pitch. Upon determining that there is a predetermined way of change in the sound volume, the determiner determines a time of the change as the note end and determine the time as the note start, irrespective of the comparison between the sound volume and the sound-volume threshold.

### CROSS-REFERENCE TO RELATED APPLICATIONS

The present application is a continuation application of International Application No. PCT/JP2021/037035, filed Oct. 6, 2021. The contents of this application are incorporated herein by reference in their entirety.

### BACKGROUND

The present disclosure relates to a sound control device, a method of controlling a sound control device, an electronic musical instrument, and a non-transitory computer-readable storage medium.

Some musical instruments serve as sound control devices that determine the initiation and termination of notes (the start and end of a note) in real-time based on performers' operations. For example, JP 2016-206496A and JP 2014-98801A disclose a technique to determine a note based on a performer's operation and generate synthesized singing sound in real-time.

There is a case that a note is determined based on performance information generated by a performer's operation. In this case, it can be difficult for some electronic musical instruments to determine a note start and a note end. Thus, there is room for improvement in determining the start and end of a note as intended by the user.

It is an object of the present disclosure to provide a sound control device that determines a note start and a note end as intended by a performer.

### SUMMARY

One aspect is a sound control device that includes an obtainer and a determiner. The obtainer is configured to obtain performance information including sound pitch information indicating a sound pitch and sound volume information indicating a sound volume detected as a continuous quantity. The determiner is configured to determine a note start and a note end based on a comparison between the sound volume and a sound-volume threshold and based on a change in the sound pitch. Upon determining that there is a predetermined way of change in the sound volume, the determiner is configured to determine a time of the change as the note end and determine the time as the note start, irrespective of the comparison between the sound volume and the sound-volume threshold.

Another aspect is an electronic musical instrument that includes the above-described sound control device and a performance operator on which a user inputs the performance information.

Another aspect is a non-transitory computer-readable storage medium that stores a program. When the program is executed by at least one processor, the program causes the at least one processor to obtain performance information including sound pitch information indicating a sound pitch and sound volume information indicating a sound volume detected as a continuous quantity. The program also causes the at least one processor to determine a note start and a note end based on a comparison between the sound volume and a sound-volume threshold and based on a change in the sound pitch. When it is determined that there is a predetermined way of change in the sound volume, the program also causes the at least one processor to determine a time of the change as the note end and determine the time as the note start, irrespective of the comparison between the sound volume and the sound-volume threshold.

Another aspect is a computer-implemented method of controlling a sound control device. The method includes obtaining performance information including sound pitch information indicating a sound pitch and sound volume information indicating a sound volume detected as a continuous quantity. The method also includes determining a note start and a note end based on a comparison between the sound volume and a sound-volume threshold and based on a change in the sound pitch. When it is determined that there is a predetermined way of change in the sound volume, the method also includes determining a time of the change as the note end and determine the time as the note start, irrespective of the comparison between the sound volume and the sound-volume threshold.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram of a sound control system including a sound control device;

FIG. 2 is a schematic illustration of lyrics data;

FIG. 3 is a functional block diagram of the sound control device;

FIG. 4 is a schematic illustration of how to identify a syllable;

FIG. 5 is a schematic illustration of how to identify a syllable;

FIG. 6 is a schematic illustration of how to identify a syllable;

FIG. 7 is a flowchart of sound generation processing;

FIG. 8 is a schematic illustration of a relationship between a musical score and a syllable-assigned note;

FIG. 9 is a schematic illustration of a generation example in which a syllable note is generated and a countermeasure example in which a countermeasure has been applied to the generation example;

FIG. 10 is a schematic illustration of an example way in which obtained sound volume changes;

FIG. 11 is a flowchart of instruction processing;

FIG. 12 is a flowchart of instruction processing; and

FIG. 13 is a flowchart of instruction processing;

### DETAILED DESCRIPTION OF THE EMBODIMENTS

The present specification is applicable to a sound control device, a method of controlling a sound control device, an electronic musical instrument, and a non-transitory computer-readable storage medium.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure.

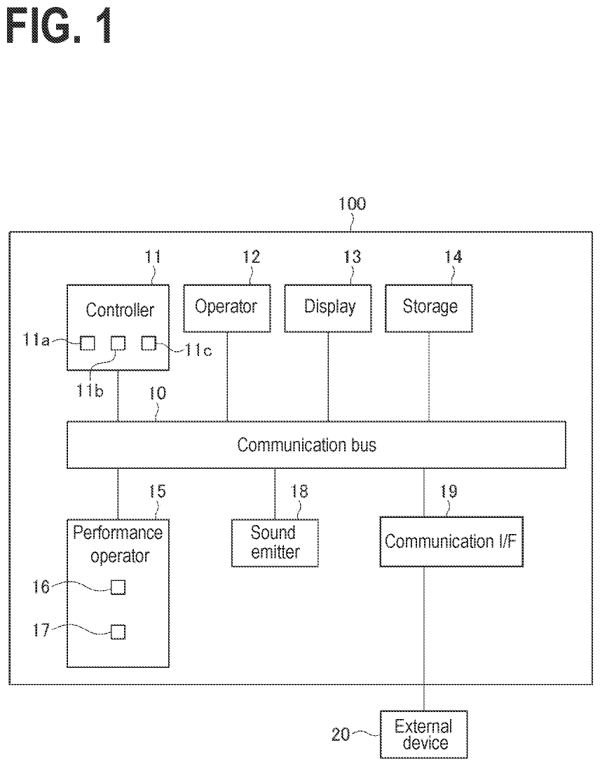

FIG. 1 is a block diagram of a sound control system including a sound control device according to an embodiment. The sound control system includes a sound control device 100 and an external device 20. In one example, the sound control device 100 can be an electronic musical instrument. Specifically, the sound control device 100 can be an electronic wind instrument such as a saxophone.

The sound control device 100 includes a controller 11, an operator 12, a display 13, a storage 14, a performance operator 15, a sound emitter 18, and a communication I/F (interface) 19. These elements are connected to each other via a communicate bus 10.

The controller 11 includes a CPU 11a, a ROM 11b, a RAM 11c, and a timer (not illustrated). The ROM 11b stores a control program executed by the CPU 11a. In the RAM 11c, the CPU 11a develops and executes the control program stored in the ROM 11b to implement various functions of the sound control device 100. The various functions include, for example, a function to perform sound generation processing. The sound generation function will be described later.

The controller 11 includes a DSP (Digital Signal Processor) that generates an audio signal as part of the sound generation function. The storage 14 is a nonvolatile memory. The storage 14 stores setting information used to generate an audio signal indicating synthesized singing sound, and stores other information including synthesis units(which can also be referred to as phonemes or speech elements) used to generate synthesized singing sound. The setting information includes, for example, tone and obtained lyrics data. It is to be noted that one, some, or all of these pieces of information and data may be stored in the storage 14.

The operator 12 includes a plurality of operation pieces on which to input various kinds of information. On the plurality of operation pieces, the operator 12 receives instructions from a user. The display 13 displays various kinds of information. The sound emitter 18 includes a sound source circuit, an effect circuit, and a sound system.

The performance operator 15 includes a plurality of operation keys 16 and a breath sensor 17 as elements to input a performance signal (performance information). The input performance signal includes sound pitch information indicating a sound pitch and sound volume information indicating a sound volume detected as a continuous quantity, and is supplied to the controller 11. The sound control device 100 has a plurality of tone holes (not illustrated) in the body of the sound control device 100. The user (performer) handles the plurality of operation keys 16 to open or close the tone holes, specifying a desired sound pitch.

A mouthpiece is mounted on the body of the sound control device 100. The breath sensor 17 is provided near the mouthpiece. The breath sensor 17 is a breath pressure sensor that detects the breath pressure of the air that the user blows into the sound control device 100 through the mouthpiece. The breath sensor 17 determines whether air has been blown into the sound control device 100. In the midst of a musical performance (hereinafter simply referred to as “performance”), the breath sensor 17 detects the level (intensity or strength) and/or speed (force) of the breath pressure. The sound volume is specified based on a change in the breath pressure detected by the breath sensor 17. The change over time in the level of the breath pressure detected by the breath sensor 17 is treated as the sound volume detected as continuous quantity information.

The communication I/F 19 is connected to a communication network in a wireless or wired manner. The sound control device 100, at the communication I/F 19, is communicably connected to the external device 20 through the communication network. An example way of the communication network may be an Internet network. The external device 20 may be a server device. The communication network, alternatively, may be a Bluetooth (registered trademark) network, an infrared communication network, or a short-range wireless communication network using a local area network (LAN).d It is to be noted that there is no particular limitation to the number and kinds of external apparatuses or devices connected to the sound control device 100. The communication I/F 19 may include a MIDI I/F that transmits and receives a MIDI (Musical Instrument Digital Interface) signal.

The external device 20 stores music piece data necessary for providing karaoke in such a manner that each music piece datum is linked to a music piece ID. The each music piece datum includes data related to a karaoke song, examples including lead vocal data, chorus data, accompaniment data, and karaoke caption (subtitle) data. The accompaniment data is data indicating sound that accompanies the song. The lead vocal data, chorus data, and accompaniment data may be data represented in MIDI form. The karaoke caption data is data for displaying lyrics on the display 13.

The external device 20 also stores setting data in such a manner that each setting datum is linked to a music piece ID. The setting data includes information input into the sound control device 100 for each song individually to synthesize singing sound. A song associated with a music piece ID is segmented into parts, with the setting data including lyrics data corresponding to each part. An example of the lyrics data is lyrics data corresponding to a lead vocal part among the parts. The music piece data and the setting data are linked to each other temporally.

The lyrics data may be the same as or different from the karaoke caption data. That is, while the lyrics data is similar to the karaoke caption data in that the lyrics data defines lyrics (characters) to be emitted as sound, the lyrics data is adjusted for better use in the sound control device 100.

For example, the karaoke caption data consists of the character string “ko”, “n”, “ni”, “chi”, “ha”. The lyrics data, in contrast, may be the character string “ko”, “n”, “ni”, “chi”, “wa”, which more closely matches actual sound emission and is optimized for use in the sound control device 100. This form of data may include information identifying a single segment of singing sound corresponding to two characters, and/or information identifying a phrase segmentation.

In performing sound generation processing, the controller 11 obtains, from the external device 20 via the communication I/F 19, music piece data and setting data specified by the user. Then, the controller 11 stores the music piece data and the setting data in the storage 14. As described above, the music piece data includes accompaniment data, and the setting data includes lyrics data. Also as described above, the accompaniment data and the lyrics data are linked to each other temporally.

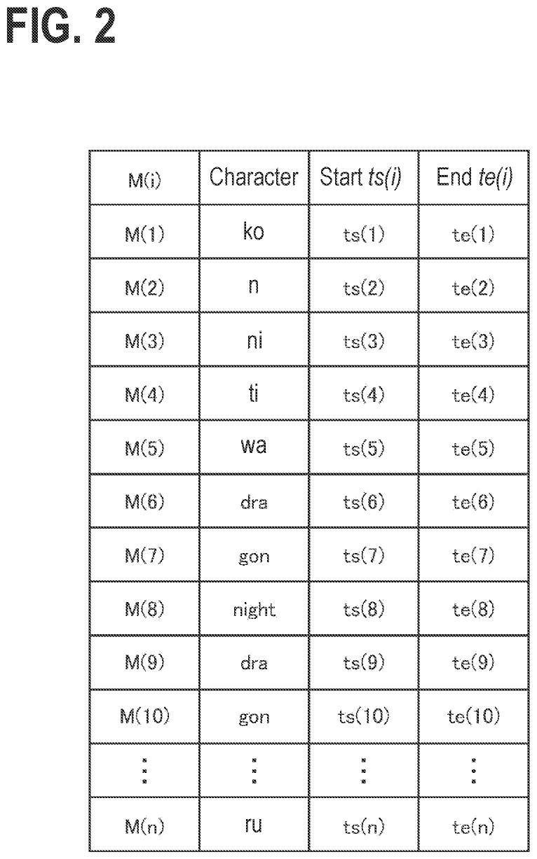

FIG. 2 is a schematic illustration of lyrics data stored in the storage 14. In the following description, each of the lyrics (characters) to be emitted as sound may occasionally be referred to as “syllable”. More specifically, the term syllable is intended to mean one unit of sound (one segment of sound). As described later by referring to FIG. 2, in the lyrics data used in this embodiment, a plurality of syllables to be emitted as sound are aligned in chronological order. Each syllable is linked to a setting time period (setting section) defined by a sound emission start time and a sound emission stop time.

The lyrics data is data that specifies a syllable to be emitted as sound. The lyrics data includes text data in which a plurality of syllables to be emitted as sound are aligned in chronological order. The lyrics data includes timing data in which the sound emission start time and the sound emission stop time for each syllable are specified on a predetermined time axis. The sound emission start time and the sound emission stop time can be defined as time based on a reference time, which can be the beginning of a music piece. In the timing data, a progress point in a song is linked to a lyric to be emitted as sound at the progress point. Thus, the lyrics data is data in which a plurality of syllables to be emitted as sound are aligned in chronological order and a syllable corresponding to a time that has passed since the reference time is uniquely specified.

As illustrated in FIG. 2, the lyrics data includes text data indicating “ko”, “n”, “ni”, “chi”, “wa”, “dra”, “gon”, and “night”, “dra”, “gon”. . . M(i) is assigned to each syllable of the syllables “ko”, “n”, “ni”, “chi”, “wa”, “dra”, “gon”, and “night”, “dra”, “gon”, and “i” (i=1 to n) specifies the order of the each syllable in a lyric. For example, M(5) corresponds to the fifth syllable of the lyric.

The lyrics data includes timing data in which a sound emission start time tₛ(i) and a sound emission stop time tₑ(i) are set for each syllable M(i). For example, for M(1) “ko”, the sound emission start time is time tₛ(1), and the sound emission stop time is time tₑ₍₁₎.

Similarly, for M(n) “ru”, the sound emission start time is time tₛ(n), and the sound emission stop time is time tₑ(n). The time period ranging from time tₛ(i) to time tₑ(i), which corresponds to each syllable M(i), will be referred to as setting time period to emit sound of the syllable M(i). The setting time period indicates, for example, a time period in a case that the each syllable M(i) is emitted as sound ideally. As described below, the sound emission time period for each syllable included in synthesized singing sound is controlled based on a sound emission start instruction and a sound emission stop instruction in the form of a performance signal.

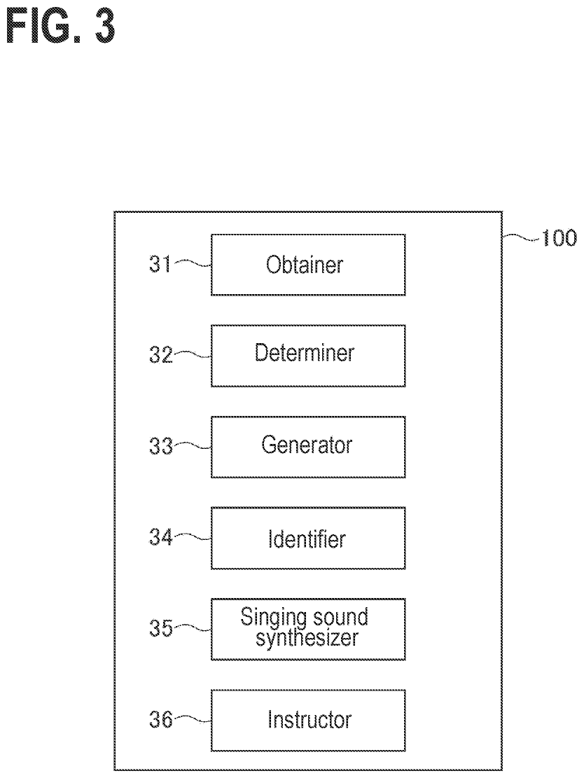

FIG. 3 is a functional block diagram of functional sections of the sound control device 100 that perform sound generation processing. The sound control device 100 includes functional sections, namely, an obtainer 31, a determiner 32, a generator 33, an identifier 34, a singing sound synthesizer 35, and an instructor 36. The functions of these functional sections are implemented through the collaborative operation of the CPU 11a, the ROM 11b, the RAM 11c, the timer, and the communication I/F 19. It is to be noted that the generator 33, the identifier 34, the singing sound synthesizer 35, and the instructor 36 may not necessarily be included in the functional sections.

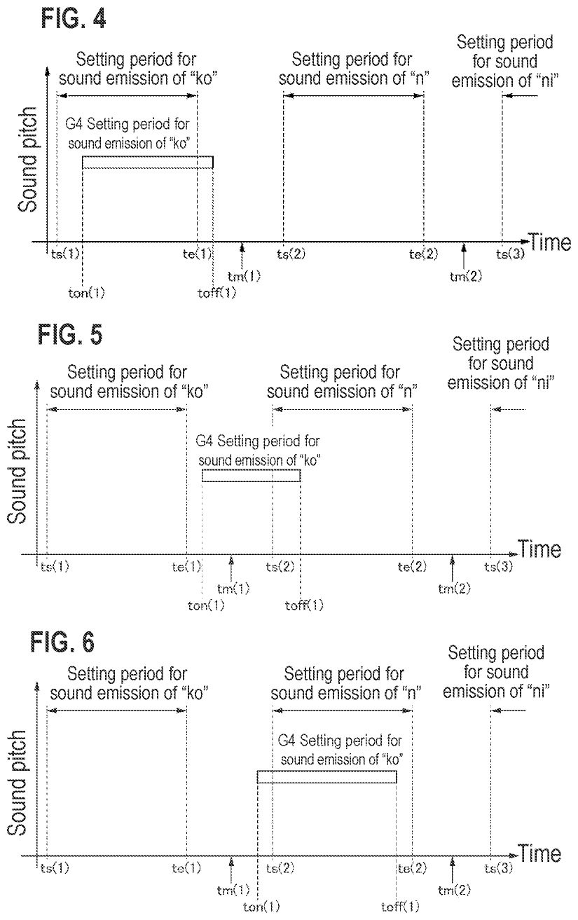

The obtainer 31 obtains a performance signal. The determiner 32 determines a note start and a note end based on a comparison between the sound volume included in the performance signal and a sound-volume threshold for the sound volume and based on a change in sound pitch in the performance signal. The generator 33 generates a note based on the determined note start and note end. The identifier 34 identifies, from the lyrics data, a syllable corresponding to the time determined as the note start. How to identify a syllable will be described later by referring to FIGS. 4 to 6.

The singing sound synthesizer 35 synthesizes the identified syllable based on the setting data to generate singing sound. The instructor 36 instructs to start sound emission of the identified syllable at a sound pitch and a time that correspond to the note start, and instructs to end the sound emission at a time corresponding to the note end. At the instruction from the instructor 36, a syllable-synthesized singing sound is emitted by the sound emitter 18 (FIG. 1).

Next, a manner in which the sound generation processing is performed will be outlined. Lyrics data and accompaniment data that correspond to a music piece specified by the user are stored in the storage 14. When the user instructs to start a performance on the operator 12, reproduction of the accompaniment data starts. Upon start of reproduction of the accompaniment data, the lyrics from the lyrics data (or the karaoke caption data) are displayed on the display 13 in synchronization with the accompaniment data's progression. Also, a musical score of a main melody that is based on the lead vocal data is displayed on the display 13 in synchronization with the accompaniment data's progression. The user plays a performance on the performance operator 15 while listening to the accompaniment data. The obtainer 31 obtains a performance signal in synchronization with the performance's progression.

In a case that the sound volume included in the performance signal exceeds a first sound-volume threshold TH1 (see FIG. 10), the determiner 32 determines the time of exceeding as a note start. In a case that the sound volume decreases to below a second sound-volume threshold TH2 (see FIG. 10) after the determiner 32 determined the note start, the determiner 32 determines the time of decreasing as a note end. The note start corresponds to the sound emission start instruction, and the note end corresponds to the sound emission end instruction. It is to be noted that the first sound-volume threshold TH1 is higher than or identical to the second sound-volume threshold TH2.

In a case that there is a change in the sound pitch while the sound volume is in excess of the first sound-volume threshold TH1, the determiner 32 determines the time of the change as a note end and determines the time of the change as a note start. That is, there may be a case that the sound pitch has been changed by operating the operation key(s) 16 by the user's finger while the breath pressure is kept at or above a predetermined level. In this case, the determiner 32 determines the note end at the pre-change sound pitch and the note start at the post-change sound pitch at the same time.

Then, at the time determined as the note start, the identified syllable is synthesized and emitted as singing sound. Then, the sound emission is stopped at the time determined as the note end. This ensures that the user only has to play the sound control device 100 to the accompaniment sound to cause the lyrics of the music piece to be emitted as sound.

FIGS. 4 to 6 are schematic illustrations of how to identify a syllable. Specifically, FIGS. 4 to 6 each illustrate a relationship between time and note.

The controller 11 (the identifier 34) selects a syllable, from among the plurality of syllables, that corresponds a setting time period including the time determined as the note start. Then, the controller 11 (the identifier 34) identifies the selected syllable as a syllable corresponding to the time determined as the note start. There may be a case that the time determined as the note start is not included in any setting time period. In this case, the controller 11 (the identifier 34) selects a syllable, from among the plurality of syllables, that corresponds to a setting time period closest to the time determined as the note start. Then, the controller 11 (the identifier 34) identifies the selected syllable as a syllable corresponding to the time determined as the note start.

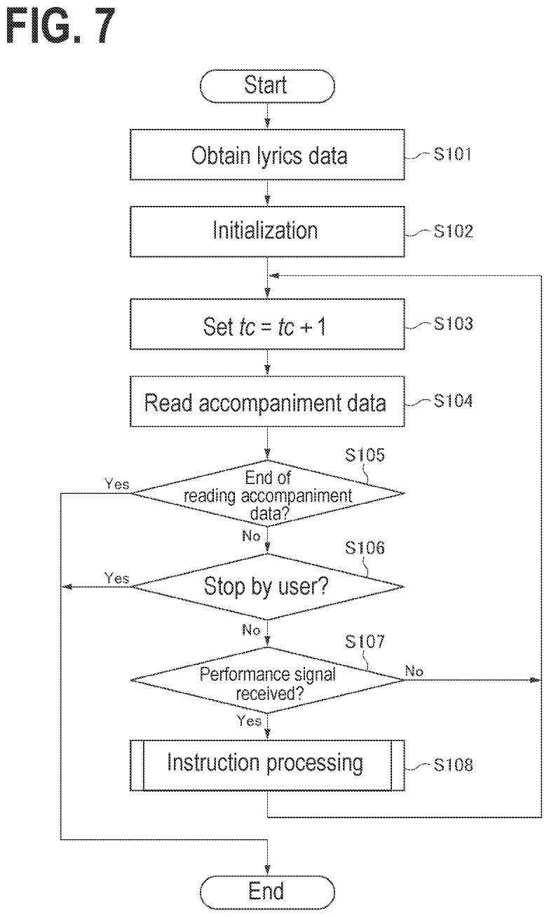

By referring to FIG. 4, an example will be described in which a count value t_{c} with a sound emission start instruction (note start) is within a sound emission setting time period of tₛ₍₁₎ to tₑ₍₁₎. The count value t_{c} is a count value for moving an accompaniment position forward in sound generation processing (described later by referring to FIG. 7).

The following description is regarding an example in which while the sound generation processing is in waiting state, a performance signal has been received that includes a start instruction for a sound emission linked to the sound pitch “G4”. In this case, the controller 11 sets the sound pitch “G4” and refers to the lyrics data to determine whether the count value t_{c} with the sound emission start instruction is included in the sound emission setting time period tₛ₍₁₎ to tₑ₍₁₎. Since the time when the sound emission start instruction was received is within the setting time period tₛ₍₁₎ to tₑ₍₁₎, the controller 11 determines that the time when the sound emission start instruction was received is included in the setting time period to emit sound of a character M(1). Then, the controller 11 identifies and sets the character “ko”, which corresponds to the character M(1), as a syllable to be emitted as sound.

After setting the sound pitch “G4” and the character “ko”, the controller 11 outputs an instruction to the DSP of the controller 11 to generate an audio signal that is based on the sound emission of the character “ko” at the sound pitch “G4” (which has been set by the controller 11). In FIG. 4, the time when the instruction to generate the audio signal based on the sound emission of the character “ko” at the sound pitch “G4” (which has been set by the controller 11) was output to the DSP of the controller 11 will be denoted as time tₒₙ₍₁₎. In response to the instruction, the DSP of the controller 11 starts generating the audio signal.

The following description is regarding an example in which while the sound generation processing is in waiting state, a performance signal has been received that includes a sound emission stop instruction (note end) linked to the sound pitch “G4”. In this case, the controller 11 sets the sound pitch “G4” and determines that the performance signal is a sound emission stop instruction. The DSP of the controller 11 outputs an instruction to stop generating the audio signal that is based on the sound emission (of the character “ko”) at the sound pitch “G4”, which has been set by the controller 11. In FIG. 4, the time when the instruction to stop generating the audio signal that is based on the sound emission of the character “ko” at the sound pitch “G4” (which has been set by the controller 11) was output will be denoted as t_{off(1)}. In response to the instruction, the DSP of the controller 11 stops generating the audio signal. In FIG. 4, the sound emission time period tₒₙ₍₁₎ to t_{off(1)} is the time period during which the audio signal based on the sound emission of the character “ko” at the sound pitch “G4” is generated.

By referring to FIG. 5, an example will be described in which the count value t_{c} with a sound emission start instruction is located between the sound emission setting time period tₛ₍₁₎ to tₑ₍₁₎ and a sound emission setting time period of tₛ₍₂₎ to tₑ₍₂₎ and adjacent to the sound emission setting time period tₛ₍₁₎ to tₑ₍₁₎. The following description is regarding an example in which while the sound generation processing is in waiting state, a performance signal has been received that includes a start instruction for a sound emission linked to the sound pitch “G4”. In this case, the controller 11 sets the sound pitch “G4” and determines whether the count value t_{c} at the time when the start instruction was received is included in the above-described sound emission setting time period. The time when the sound emission start instruction was received is not included in any sound emission setting time period corresponding to the character M(i). In this case, the controller 11 calculates a center time t_{M(i)} based on a setting time period set immediately before and immediately after the count value t_{c}.

There may be a case that the count value t_{c} at the time when the sound emission start instruction was received is located between the sound emission setting time period tₛ₍₁₎ to tₑ₍₁₎ and the sound emission setting time period tₛ₍₂₎ to tₑ₍₂₎. In this case, the controller 11 calculates a center time t_{M(1)} between a stop time tₑ₍₁₎ and a start time tₛ₍₂₎. In this example, tₘ₍₁₎=(tₑ₍₁₎+tₛ₍₂₎)/2 is obtained. Also in this example, the count value t_{c} at the time when the sound emission start instruction was received is before the center time t_{M(1)}. In light of this fact, the controller 11 identifies and sets the character “ko” (character M(1)) as a syllable to be emitted as sound, since the character “ko” (character M(1)) belongs to the setting time period before the center time t_{M(1)}. The sound emission time period tₒₙ₍₁₎ to t_{off(1)} is the time period during which the audio signal based on the sound emission of the character “ko” at the sound pitch “G4” is generated.

By referring to FIG. 6, an example will be described in which the count value t_{c} with the sound emission start instruction is located between the sound emission setting time period tₛ₍₁₎ to tₑ₍₁₎ and the sound emission setting time period tₛ₍₂₎ to tₑ₍₂₎ and adjacent to the sound emission setting time period tₛ₍₂₎ to tₑ₍₂₎. In a case that the time when the sound emission start instruction was received is not before the center time t_{M(1)}, the controller 11 identifies and sets the character “n” (character M(2)) as a syllable to be emitted as sound. The character “n” belongs to a setting time period after the center time t_{M(1)}. The sound emission time period tₒₙ₍₁₎ to t_{off(1)} is the time period during which the audio signal based on the sound emission of the character “n” at the sound pitch “G4” is generated.

Thus, a syllable corresponding to a setting time period including the time determined as the note start or a syllable corresponding to a setting time period closest to the time determined as the note start is identifies as a syllable corresponding to the time determined as the note start.

Next, the sound generation processing will be described. In the sound generation processing, an instruction to generate an audio signal corresponding to each syllable or an instruction to stop generating the audio signal is output based on the user's operation on the performance operator 15.

FIG. 7 is a flowchart of the sound generation processing. The sound generation processing is implemented by the CPU 11a developing, in the RAM 11c, the control program stored in the ROM 11b and executing the control program in the RAM 11c. The sound generation processing is started upon the user's instruction to reproduce a music piece.

The controller 11 obtains lyrics data from the storage 14 (step S101). Next, the controller 11 performs initialization processing (step S102). In the initialization processing, the count value t_{c} is set to 0, and various register values and flag values are set to their initial values.

Next, the controller 11 increments the count value t_{c} by setting the count value t_{c} to t_{c}+1 (step S103). Next, the controller 11 reads, from the accompaniment data, a datum corresponding to the count value t_{c} (step S104).

The controller 11 repeats the processings at steps S103 and S104 (No at step S105, No at step S106, No at step S107) until the controller 11 detects any one of the end of reading the accompaniment data, the user's input of an instruction to stop the performance of the music piece, or the receipt of a performance signal. This repetition state corresponds to a waiting state. As described above, the initial value of the count value t_{c} is 0, which corresponds to the time when the reproduction of the music piece starts. The controller 11 increments the count value t_{c} to measure time based on the time when the reproduction of the music piece starts.

In the waiting state, in a case that reading of the accompaniment data ends by fully reading the accompaniment data (Yes at step S105), the controller 11 ends the sound generation processing. In the waiting state, in a case that the user has input an instruction to stop the performance of the music piece (Yes at step S106), the controller 11 ends the sound generation processing.

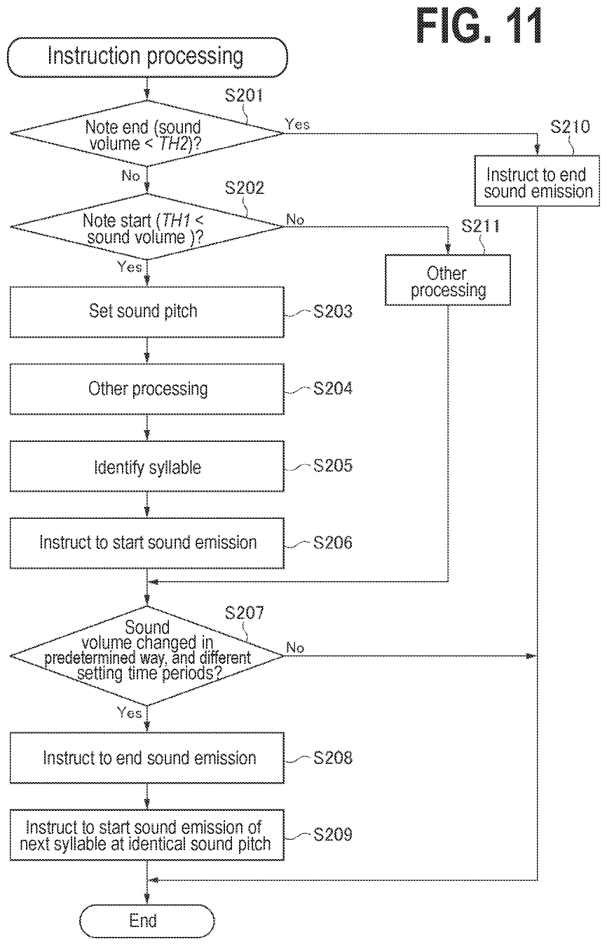

In the waiting state, in a case that the controller 11 has received a performance signal from the performance operator 15 (Yes at step S107), the controller 11 performs instruction processing to cause the DSP of the controller 11 to generate an audio signal (step S108). The instruction processing to generate an audio signal will be detailed later by referring to FIG. 11. Upon ending of the instruction processing to generate the audio signal, the controller 11 returns the procedure to step S103 into a waiting state of repeating steps S103 and S104.

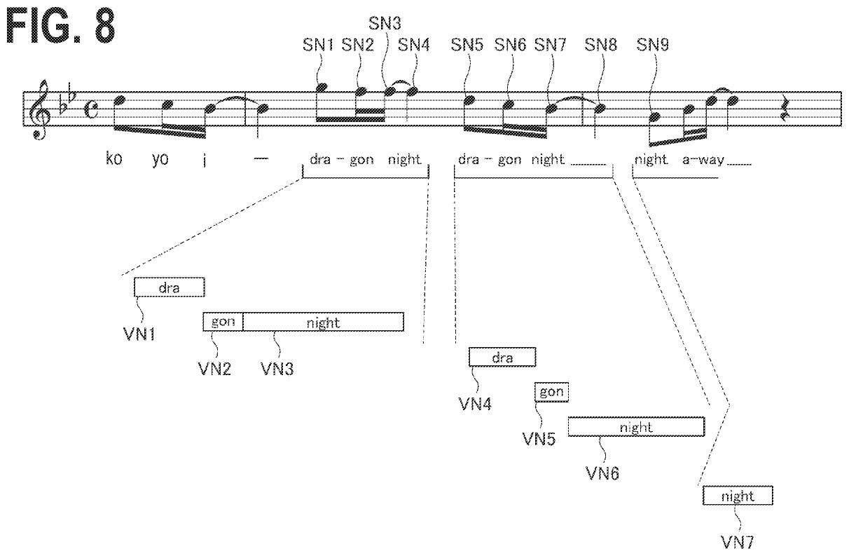

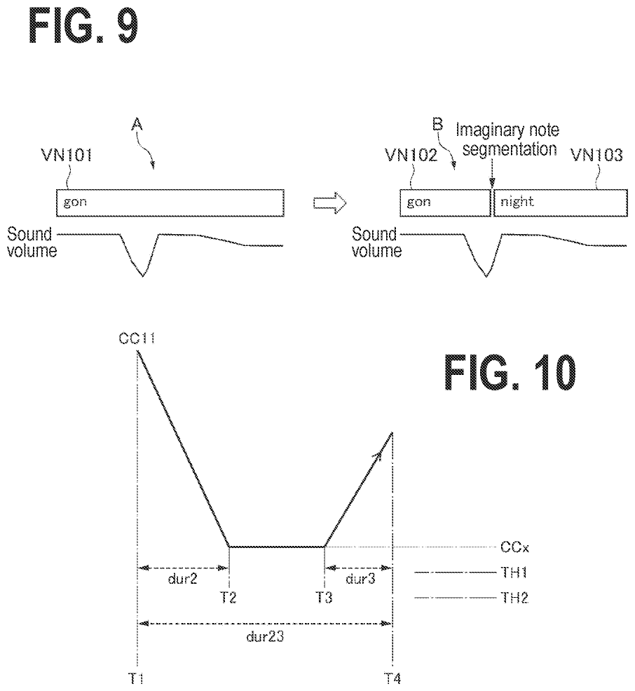

By referring to FIGS. 8 and 9, description will be made with regard to an example in which notes are generated by a performance and syllables are assigned to the respective notes. FIG. 8 is a schematic illustration of a relationship between part of a musical score of a main melody of a music piece specified by the user and syllable-assigned notes generated by the performance of the music piece. In this example, the syllable-assigned notes will be referred to as syllable notes VN1 to VN7. Musical notes SN1 to SN9 correspond to one of the syllables in the lyrics data. In FIG. 8, the syllable notes VN1 to VN7 represent an ideal execution achieved by the user through precise performance aligning with the musical notes SN1 to SN9. A precise performance at an appropriate time refers to such a performance that the note starts at a corresponding time in a corresponding setting time period.

For example, the musical notes SN1, SN2, and SN3 respectively correspond to syllables “dra”, “gon”, and “night”. In a case that the user plays the musical notes SN1, SN2, and SN3 at appropriate times to an accompaniment, the syllable notes VN1, VN2, and VN3 are emitted as sound and generated as notes. The syllable notes VN1, VN2, and VN3 are respectively assigned with the syllables “dra”, “gon”, and “night”. The musical note SN3 and the musical note SN4 are connected with a tie and correspond to a single syllable note VN3, “night”.

Similarly, in a case that the user plays the musical notes SN5 to SN9 at appropriate times to an accompaniment, the syllable notes VN4 to VN7 are emitted as sound and generated as notes. The musical note SN7 and the musical note SN8 are connected with a tie and correspond to a single syllable note VN6, “night”.

It is to be noted that while a syllable note is emitted as sound in real-time, a generated syllable note can be stored as vocal synthesis data that includes syllable information. Alternatively, a generated syllable note can be stored in the form of MIDI data not including syllable data.

FIG. 9 is a schematic illustration of a generation example in which a syllable note is generated and a countermeasure example in which a countermeasure has been applied to the generation example. Case A is an undesirable case, and case B is an example in which a countermeasure has been applied to case A. Case B is implemented by instruction processing (described later by referring to FIG. 11).

Case A is an example in which while the user intended to play the musical notes SN2 and SN3 continuously, a single long syllable note VN101 was emitted as sound and generated, when two syllable notes VN2 and VN3 should be emitted as sound and generated. However, since the sound volume detected between the musical notes SN2 and SN3 did not decrease sufficiently, the syllable note was not segmented.

This phenomenon is likely to occur when the musical note SN2, which is a 1/16 musical note, is followed by the musical note SN3, which has the same sound pitch as the musical note SN2. Specifically, the above phenomenon is likely to occur when the former musical note of continuous same-sound-pitch musical notes has a short time value. An example of how the above phenomenon occurs will be described by referring to FIG. 10.

FIG. 10 is a schematic illustration of an example way in which obtained sound volume changes. CC 11 is a control change indicating a change (expression) in sound volume.

If the sound volume exceeds the first sound-volume threshold TH1, the time of exceeding is determined as a note start. In this case, if the sound volume changes in the predetermined way illustrated in FIG. 10, that is, if the sound volume stays above the second sound-volume threshold TH2, it is not determined that a note end has been identified. For example, there may be a case that even if the user plays the musical note SN2 to emit sound of the syllable note VN101 and then intends to play the musical note SN3 after temporarily decreasing the breath pressure, the sound volume never falls below the second sound-volume threshold TH2. In this case, as illustrated in case A, “gon” is assigned to the syllable note VN101, and the next syllable “night” is not assigned to the syllable note VN101.

In this embodiment, in this case, as illustrated in case B, the controller 11 inserts (locates) an imaginary note segmentation along the syllable note VN101 to divide the syllable note VN101 into two syllable notes VN102 and VN103. The end time of the syllable note VN102 is the same as the start time of the syllable note VN103, which is not illustrated in FIG. 9. Specifically, upon determining that there was the predetermined way of change in the sound volume, the controller 11 determines the time when the sound volume changed in the predetermined way as a note end, and determines the time as a note start, irrespective of the comparison between the sound volume and the thresholds (the thresholds TH1 and TH2). That is, the controller 11 determines a time as a note end and a note start to simultaneously insert an imaginary note segmentation.

In order to distinguish the user's purposeful continuation from the user's purposeful segmentation, the predetermined way illustrated in FIG. 10 has the following definition, and information of the definition is stored in the ROM 11b. If the way in which the sound volume changes corresponds to the predetermined way, it can be determined that the user is purposefully dividing the note.

The above-described predetermined way is defined as follows. The sound volume decreases at a speed higher than a first predetermined speed within a first predetermined time dur 2; and after the sound volume started decreasing and before passage of a second predetermined time dur 23, the sound volume continues increasing beyond a third predetermined time dur 3 at a speed higher than a second predetermined speed.

In this definition, the first predetermined time dur 2 is the time from a decrease start time T1 to a decrease end time T2. For example, the first predetermined time dur 2 is in the range of 20 milliseconds (ms) to 100 ms. The second predetermined time dur 23 is the time from the decrease start time T1 to an increase end time T4. For example, the second predetermined time dur 23 is 200 ms. The third predetermined time dur 3 is the time from the increase start time T3 to the increase end time T4. For example, third predetermined time dur 3 is 10 ms. An example of the first predetermined speed and the second predetermined speed is 0.5 CC/ms. The first predetermined speed and the second predetermined speed may not necessarily be the same value. It is to be noted that the above-described values are provided for exemplary purposes only and are not intended in a limiting sense. It is also to be noted that the above-described values may be changed based on the reproduction tempo. It is also to be noted that a minimum sound volume, CCx, that satisfies the above-described predetermined way is usually higher than the first sound-volume threshold TH1.

FIG. 11 is a flowchart of the instruction processing performed at step S108 illustrated in FIG. 7.

First, at step S201, the controller 11 compares the sound volume indicated by the obtained performance signal with the second sound-volume threshold TH2 to determine whether a note end (sound emission end instruction) has been identified. In this example, in a case that the sound volume falls below the second sound-volume threshold TH2, the time of the falling is determined as a note end. In a case that it is not determined that a note end has been identified, then at step S202, the controller 11 determines whether a note start (sound emission start instruction) has been identified. In this example, in a case that the sound volume exceeds the first sound-volume threshold TH1, the time of the exceeding is determined as a note start.

In a case that it is determined as a note end at step S201, then at step S210, the controller 11 instructs to end the emission of the sound of the syllable whose sound is being emitted at a time corresponding to the current note end. Thus, the controller 11 ends the processing illustrated in FIG. 11. Specifically, the controller 11 outputs, to the DSP of the controller 11, an instruction to stop generating the audio signal that has been started to be generated at step S206 or step S209, described later. Thus, the sound that is being emitted is omitted.

In a case that it is not determined that a note start has been identified at step S202, the controller 11 performs an other processing at step S211. Then, the controller 11 proceeds the procedure to step S207. An example of the other processing is that in a case that the sound volume obtained during sound emission has changed while staying above the second sound-volume threshold TH2, the controller 11 outputs an instruction to change the sound emission sound volume based on the change.

In a case that it is determined that a note start has been identified at step S202, then at step S203, the controller 11 sets the sound pitch indicated by the obtained performance signal. At step S204, the controller 11 performs an other processing. An example of the other processing is that in a case that the sound pitch has been changed in a setting time period, the controller 11 continues the emission of the sound of the syllable whose sound is being emitted at the post-change sound pitch without ending the sound emission of the syllable. For example, the sound emission of the syllable “night” is continued at the post-change sound pitch. The syllable note corresponding to the post-change sound pitch is assigned with “-”, which indicates long sound.

At step S205, the controller 11 identifies a syllable corresponding to the time determined as the current note start by the methods described above by referring to FIGS. 4 to 6. At step S206, the controller 11 instructs to start sound emission of the identified syllable at a sound pitch and a time that correspond to the current note start. Specifically, the controller 11 outputs, to the DSP of the controller 11, an instruction to start generating an audio signal based on the sound pitch that has been set and sound emission of the identified syllable.

At step S207, the controller 11 determines whether there was the above-described predetermined way (FIG. 10) of change in the sound volume indicated by the performance signal. Upon determining that there was the above-described predetermined way of change in the sound volume, the controller 11 further determines whether the setting time period including the time determined as the current note start is different from the setting time period including the time when the sound volume was determined as having changed in the above-described predetermined way. The controller 11 proceeds the procedure to step S208 in a case that the following conditions are satisfied: there was the above-described predetermined way of change in the sound volume; and the above-described two setting time periods are different from each other. In a case that the conditions are not satisfied, the controller 11 ends the processing illustrated in FIG. 11.

At step S208, the controller 11 instructs to end the sound emission of the currently identified syllable at a time corresponding to the current note end. At step S209, the controller 11 instructs to start sound emission of the next syllable at a sound pitch approximately identical to the sound pitch of the immediately previous sound emission (the sound emission that started at previous step S206). Thus, at steps S208 and S209, the controller 11 determines the time when the sound volume changed in the predetermined way as a note end and determines the time as a note start, irrespective of the comparison between the sound volume and the thresholds. In this manner, an imaginary note segmentation is inserted (case B).

Thus, the controller 11 determines the time when the sound volume changed in a predetermined way as a note end and determines the time as a note start on condition that the setting time period including the time determined as the note start is different from the setting time period including the time when the sound volume was determined as having changed in the predetermined way. In other words, even if the sound volume changes in the predetermined way in the same setting time period, no imaginary note segmentation is inserted. This prevents a segmentation from being inserted at a point where no segmentation is necessary. After step S209, the controller 11 ends the processing illustrated in FIG. 11.

In this embodiment, the controller 11 determines a note start and a note end based on a comparison between the sound volume included in the obtained performance signal and the sound-volume thresholds for the sound volume and based on a change in sound pitch in the performance signal (S201, and S202). Upon determining that there was the predetermined way (FIG. 10) of change in the sound volume, the controller 11 determines the time when the sound volume changed in the predetermined way as a note end, and determines the time as a note start, irrespective of the comparison between the sound volume and the thresholds. Thus, the controller 11 is capable of determining the start and end of a note as intended by the user.

By setting the predetermined way of change as in FIG. 10, the user's purposeful continuation can be distinguished from the user's purposeful segmentation. This ensures that the start and end of a note can be appropriately determined.

Also, since a note is generated based on the determination of the note start and the note end, the note can be generated as intended by the user.

Also, when the controller 11 emits sound of a syllable-synthesized singing sound, the controller 11 causes sound emission of the identified syllable to start at a sound pitch and a time that correspond to the note start, and causes the sound emission to end at a time corresponding to the note end. This enables singing sound to be emitted as sound in real-time. Additionally, a syllable corresponding to the setting time period including the time determined as the note start or a syllable corresponding to a setting time period closest to the time determined as the note start is identified as a syllable corresponding to the time determined as the note start. This enables a syllable to be emitted as sound as intended by the user.

In an embodiment, the characters M(i)=M(1) to M(n)in the lyrics data (FIG. 2) are emitted as sound in order. In this configuration, in the sound generation processing (FIG. 7), the timing data that specifies the sound emission setting time period in the lyrics data may be disregarded. Alternatively, the timing data may be omitted in the lyrics data.

In the previous embodiment, a plurality of syllables to be emitted as sound are aligned in chronological order in the lyrics data. Also in the previous embodiment, each syllable is linked to a setting time period including a sound emission start time and a sound emission stop time. Accordingly, the methods illustrated in FIGS. 4 to 6 to identify a syllable are employed in the previous embodiment. Because of this configuration, even if the time of performance is shifted from the original setting period, a syllable corresponding to a setting time period that includes the time of performance (or adjacent to such setting time period) is identified and emitted as sound. In contrast, in this embodiment, syllables are identified in order based on a performance's progression.

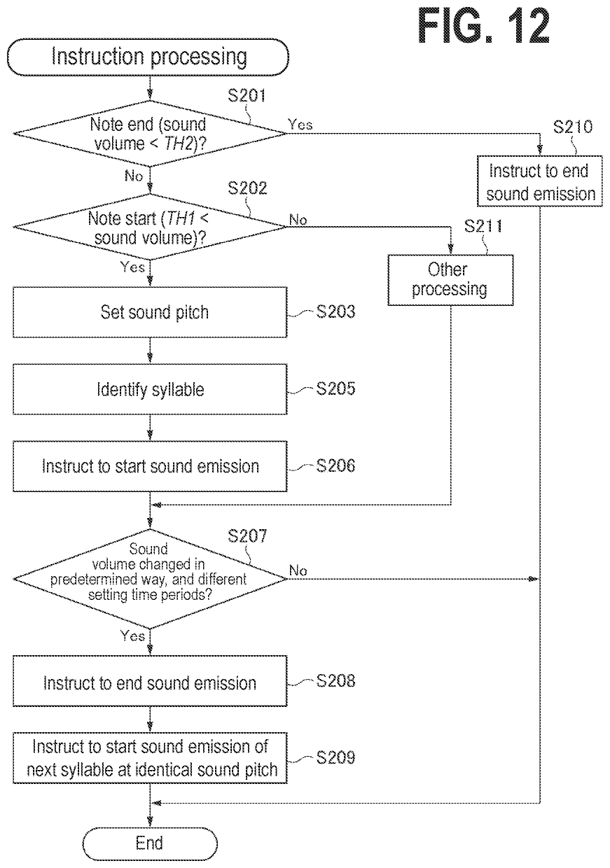

In this embodiment, the processing illustrated in FIG. 12, instead of the processing illustrated in FIG. 11, is applied to the instruction processing performed at step S108 illustrated in FIG. 7. FIG. 12 is a flowchart of the instruction processing performed at step S108 illustrated in FIG. 7. Throughout FIGS. 11 and 12, identical steps are appended with identical step numbers. Step S204 is omitted.

In this embodiment, in the initialization processing at step S102 illustrated in FIG. 7, the controller 11 performs processing of setting the character count value i=1 (character M(i)=M(1)) in M(i) and setting tₛ=0, in addition to the processing performed in the previous embodiment. In M(i), “i” denotes a sound emission order of a syllable in lyrics. “tₛ” denotes the time when the immediately previous sound emission start instruction was received. By incrementing “i”, the controller 11 increments the syllable indicated by M(i) one by one, among the syllables constituting the lyrics. In FIG. 7, the other steps are as described in the previous embodiment.

Steps S201 to S203, and S210 illustrated in FIG. 12 and the processing at S211 are as described in the previous embodiment. At step S205, the controller 11 identifies a syllable indicated by the character M(i) as the current syllable. Accordingly, the syllables are identified according to the order in which the syllables are aligned in the lyrics data. At step S206, the controller 11 instructs to start sound emission of the identified syllable at a sound pitch and a time that correspond to the current note start.

At step S207, the controller 11 determines whether there was the above-described predetermined way (FIG. 10) of change in the sound volume indicated by the performance signal. This embodiment is different from the previous embodiment in that no setting time period is taken into consideration. In a case that there was the above-described predetermined way of change in the sound volume, the controller 11 proceeds the procedure to step S208. In a case that the sound volume did not change in the above-described predetermined way, the controller 11 ends the processing illustrated in FIG. 12.

At step S208, the controller 11 instructs end the emission of the sound of the first syllable that has been currently identified (the syllable whose sound started being emitted at previous step S206). At step S209, the controller 11 instructs to start sound emission of the second syllable next to the first syllable at a sound pitch approximately identical to the sound pitch of the sound emission of the first syllable (the sound emission that started at previous step S206). The second syllable is a syllable next to a syllable (first syllable) in the order in the lyrics data. By this processing, the user's intension is determined based on the way in which the sound pitch changes, and an imaginary note segmentation is inserted. This enables a syllable to be emitted as sound as intended by the user. After step S209, the controller 11 ends the processing illustrated in FIG. 12.

In this embodiment, the time when the sound volume changed in the predetermined way is determined as a note end and determined as a note start. Thus, the start and end of a note is determined as intended by the user. This effect of the embodiment is similar to the effect provided by the previous embodiment.

Also, syllables are identified and emitted as sound in order based on a performance's progression. This enables a syllable to be emitted as sound as intended by the user.

In an embodiment, a syllable is not identified and emitted as sound. Instead, performance sound (for example, wind instrument sound) is emitted based on a performance's progression. Because of this configuration, the lyrics data (FIG. 2) is not essential in this embodiment. Also, music piece data including accompaniment data is not essential.

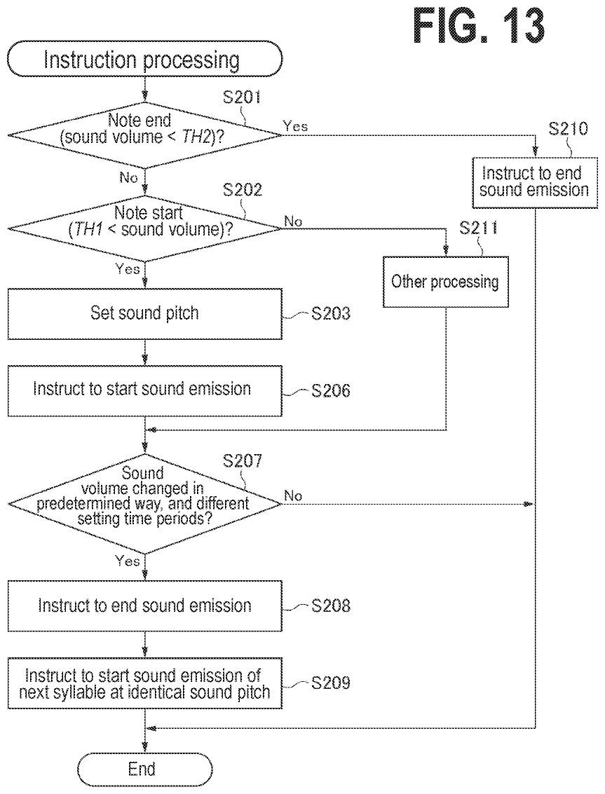

In this embodiment, the processing illustrated in FIG. 13, instead of the processing illustrated in FIG. 11, is applied to the instruction processing performed at step S108 illustrated in FIG. 7. FIG. 13 is a flowchart of the instruction processing performed at step S108 illustrated in FIG. 7. Throughout FIGS. 11 and 13, identical steps are appended with identical step numbers. Steps S204 and S205 are omitted.

Steps S201 to S203 illustrated in FIG. 12 and the processing at S211 are as described in the previous embodiment. At step S206, the controller 11 instructs to start sound emission at a sound pitch and a time that correspond to the current note start. It is to be noted that the sound may be emitted at a predetermined tone. At an other processing at step S211, the tone may be changed by the user's operation. At step S210, the controller 11 instructs end the emission of the sound that is being emitted at a time corresponding to the current note end. Then, the controller 11 ends the processing illustrated in FIG. 13.

At step S207, the controller 11 determines whether there was the above-described predetermined way (FIG. 10) of change in the sound volume indicated by the performance signal. This embodiment is different from the previous embodiment in that no setting time period is taken into consideration. In a case that there was the above-described predetermined way of change in the sound volume, the controller 11 proceeds the procedure to step S208. In a case that the sound volume did not change in the above-described predetermined way, the controller 11 ends the processing illustrated in FIG. 13.

At step S208, the controller 11 instructs to end the emission of the sound that is being emitted. At step S209, the controller 11 instructs to start a sound emission again at a sound pitch approximately identical to the sound pitch at the time when the sound emission started at previous step S206. By this processing, the user's intension is determined based on the way in which the sound pitch changes, and an imaginary note segmentation is inserted. After step S209, the controller 11 ends the processing illustrated in FIG. 13.

In this embodiment, the time when the sound volume changed in the predetermined way is determined as a note end and determined as a note start. Thus, the start and end of a note is determined as intended by the user. This effect of the embodiment is similar to the effect provided by the previous embodiment. Also, sound emission that dynamically mirrors the user's intentions can be performed, rather than merely emitting syllabic sounds.

It is to be noted that in the previous embodiment, the sound control device 100 may be any other wind instrument provided with a breath sensor insofar as the sound volume of the wind instrument can be measured as a continuous quantity. The sound control device 100 will even not be limited to a wind instrument but may be any other musical instrument such as a keyboard instrument. For example, in a case that the present disclosure is applied to a keyboard instrument, each of the keys may be provided with functions such as a function of an after sensor so that the sound volume of the keyboard instrument changes continuously based on the user's key operation. The sound control device 100 may also be an electronic musical instrument connected with a volume pedal that is operated by the user to input sound volume information.

It is to be noted that the performance signal (performance information) may be obtained from outside via a network. Because of this configuration, the performance operator 15 is not essential, and the sound control device 100 may not necessarily have functions and forms characteristic of a musical instrument.

It is also to be noted that the sound emitter 18 is not essential. Specifically, synthesized singing sound or information of sound to be emitted may be transmitted to an external device having the function of the sound emitter 18 via a network, and the external device may emit the sound. Also, an external device connected to the sound control device 100 through the communication I/F 19 may have at least one function of the generator 33, the identifier 34, the singing sound synthesizer 35, and the instructor 36.

It will be understood that the control program described above, represented in software form, can be saved on a storage medium. This allows the program to be loaded into the device according to the above-described embodiment to fulfill its intended functions. This configuration provides effects similar to the effects provided by the present disclosure. In this case, the program's code read from the storage medium fulfill the novel functions. Accordingly, a non-transitory computer readable storage medium storing the code embodies the present disclosure. It will also be understood that the program's code may be supplied through a transmission medium. In this case, the program's code itself embodies the present disclosure. Examples of the storage medium include a ROM, a floppy disk, a hard disk, an optical disk, a magneto-optical disk, a CD-ROM, a compact CD-R, a magnetic tape, and a nonvolatile memory card. The non-transitory computer readable storage medium may be a memory that holds the program for a predetermined period of time. An example of such memory is a volatile memory (for example, a DRAM (Dynamic Random Access Memory)) provided inside a computer system including a server or a client from or to which the program is transmitted via a network such as the Internet or a communication line such as a telephone line.

While embodiments have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A sound control device comprising:
an obtainer configured to obtain performance information including:
sound pitch information indicating a sound pitch; and
sound volume information indicating a sound volume detected as a continuous quantity; and
a determiner configured to determine a note start and a note end based on a comparison between the sound volume and a sound-volume threshold and based on a change in the sound pitch,
wherein upon determining that there is a predetermined way of change in the sound volume, the determiner is configured to determine a time of the change as the note end and determine the time as the note start, irrespective of the comparison between the sound volume and the sound-volume threshold.

2. The sound control device according to claim 1, further comprising a generator configured to generate a note based on the note start and the note end determined by the determiner.

3. The sound control device according to claim 1, wherein the predetermined way is that:
the sound volume decreases at a speed higher than a first predetermined speed within a first predetermined period of time; and
before passage of a second predetermined period of time since the sound volume started decreasing, the sound volume continues increasing at a speed higher than a second predetermined speed and in excess of a third predetermined time.

4. The sound control device according to claim 1, wherein in a case that the sound volume exceeds a first sound-volume threshold, the determiner is configured to determine a time when the sound volume exceeds the first sound-volume threshold as the note start.

5. The sound control device according to claim 4, wherein in a case that the sound volume becomes lower than a second sound-volume threshold after the determiner determined the time when the sound volume exceeds the first sound-volume threshold as the note start, the determiner is configured to determine a time when the sound volume becomes lower than the second sound-volume threshold as the note end.

6. The sound control device according to claim 4, wherein in a case that there is a change in the sound pitch while the sound volume is in excess of the first sound-volume threshold, the determiner is configured to determine a time of the change as the note end and determine the time as the note start.

7. The sound control device according to claim 1, further comprising:
an identifier configured to identify a syllable, from lyrics data in which a plurality of syllables each to be emitted as sound are aligned in chronological order, that corresponds to the time determined by the determiner as the note start; and
an instructor configured to:
instruct to start emission of the sound of the syllable identified by the identifier at the time of the note start and at a sound pitch corresponding to the note start; and
instruct to end the emission of the sound of the syllable at the time of the note end.

8. The sound control device according to claim 7, wherein
the instructor is configured to instruct to start emission of the sound of a first syllable corresponding to the note start, and
in a case that the time of the predetermined way of change in the sound volume is determined as the note end and determined as the note start after the emission of the sound of the first syllable started, the instructor is configured to:
instruct to end the emission of the sound of the first syllable; and
instruct to start emission of the sound of a second syllable that is next to the first syllable at a sound pitch approximately identical to a sound pitch at which the sound of the first syllable was emitted.

9. The sound control device according to claim 7, wherein
each syllable of the plurality of syllables in the lyrics data is linked to a setting section defined by a sound emission start time and a sound emission stop time, and
the identifier is configured to:
select a syllable, from among the plurality of syllables, that corresponds to a setting section including the time determined as the note start or a setting section closest to the time determined as the note start; and
identify the selected syllable as a syllable corresponding to the time determined as the note start.

10. The sound control device according to claim 9, wherein the determiner is configured to determine the time of the predetermined way of change in the sound volume as the note end and determine the time as the note start in a case that the setting section including the time determined as the note start is different from a setting section including the time when the sound volume was determined to be change in the predetermined way.

11. The sound control device according to claim 7, further comprising a sound emitter configured to emit a singing sound synthesized with the syllable at an instruction from the instructor.

12. The sound control device according to claim 1, further comprising an instructor configured to:
instruct to start emission of sound at the time of the note start and at a sound pitch corresponding to the note start; and
instruct to end the emission of the sound at the time of the note end.

13. An electronic musical instrument comprising:
the sound control device according to claim 1; and
a performance operator on which a user inputs the performance information.

14. The electronic musical instrument according to claim 13, wherein
the performance operator comprises a breath sensor configured to detect a pressure change, and
the sound volume information is obtained based on the pressure change detected by the breath sensor.

15. A non-transitory computer-readable storage medium storing a program which, when executed by at least one processor, causes the at least one processor to:
obtain performance information including:
sound pitch information indicating a sound pitch; and
sound volume information indicating a sound volume detected as a continuous quantity;
determining a note start and a note end based on a comparison between the sound volume and a sound-volume threshold and based on a change in the sound pitch; and
when it is determined that there is a predetermined way of change in the sound volume, determining a time of the change as the note end and determining the time as the note start, irrespective of the comparison between the sound volume and the sound-volume threshold.

16. A computer-implemented method of controlling a sound control device, the method comprising:
obtaining performance information including:
sound pitch information indicating a sound pitch; and
sound volume information indicating a sound volume detected as a continuous quantity;
determining a note start and a note end based on a comparison between the sound volume and a sound-volume threshold and based on a change in the sound pitch; and
when it is determined that there is a predetermined way of change in the sound volume, determining a time of the change as the note end and determining the time as the note start, irrespective of the comparison between the sound volume and the sound-volume threshold.
